(19) United States
(12) Patent Application Publication
(10) Pub. No.: US 2024/0393573 A1
(43) Pub. Date: Nov. 28, 2024

(54) IMAGING APPARATUS

(71) Applicant: FUJIFILM Corporation, Tokyo (JP)

(72) Inventors: Kota SHIMAZAKI, Saitama (JP); Motoari OTA, Saitama (JP); Takuya TANAKA, Saitama (JP)

(73) Assignee: FUJIFILM Corporation, Tokyo (JP)

(21) Appl. No.: 18/669,015

(22) Filed: May 20, 2024

(30) Foreign Application Priority Data
May 25, 2023 (JP) 2023-086526

(51) Int. Cl. G02B 15/14; G02B 9/64

(52) U.S. Cl. CPC G02B 15/1461; G02B 9/64

(57) ABSTRACT

An imaging apparatus includes an imaging optical system including a plurality of lenses, and a curved imaging surface that is disposed at an image forming position of the imaging optical system and that has a concave surface toward an object side. The imaging apparatus satisfies predetermined conditional expressions.

### CROSS-REFERENCE TO RELATED APPLICATIONS

This application claims priority from Japanese Patent Application No. 2023-086526, filed on May 25, 2023, the entire disclosure of which is incorporated herein by reference.

### BACKGROUND

### Technical Field

The disclosed technology relates to an imaging apparatus.

### Related Art

An imaging apparatus including an imaging lens including a plurality of lenses and a curved imaging surface is disclosed in JP2021-043385A.

### SUMMARY

An imaging apparatus having a small size and favorable performance is desired. A level of such demands is increased year by year.

An object of the present disclosure is to provide an imaging apparatus having a small size and favorable performance.

An imaging apparatus according to one aspect of the present disclosure is an imaging apparatus comprising an imaging optical system including a plurality of lenses, and a curved imaging surface that is disposed at an image forming position of the imaging optical system and that has a concave surface toward an object side, in which Conditional Expressions (1), (2), and (3) below are satisfied.

$$- 0.3 < Bf / Ri < - 0 \text{.005} \qquad ( 1 )$$

$$- 5 < ( R r + Ri ) / ( Rr - R i ) < - 0.1 \qquad ( 2 )$$

$$0.1 < EDf / TL < 0.8 \qquad ( 3 )$$

Here, symbols of the conditional expressions are defined as follows. A back focus of the imaging optical system as an air conversion distance is denoted by Bf. A curvature radius of the imaging surface is denoted by Ri. A paraxial curvature radius of a lens surface of the imaging optical system closest to an image side is denoted by Rr. An effective diameter of a lens surface of the imaging optical system closest to the object side is denoted by EDf. A sum of Bf and a distance on an optical axis from the lens surface of the imaging optical system closest to the object side to the lens surface of the imaging optical system closest to the image side is denoted by TL.

The imaging apparatus of the aspect preferably satisfies at least one of Conditional Expressions (4), (5), (6), (7), (8), or (9) below.

$$0 \text{.3} < TL / f < 9 \qquad ( 4 )$$

$$0.5 < ( TL / f ) \times FNo < 23 \qquad ( 5 )$$

$$0.3 < EDf / ( f \times tan ω ) < 5 \qquad ( 6 )$$

$$0.1 < Bf / ( f \times tan ω ) < 5 \qquad ( 7 )$$

$$0.1 < Bf / TL < 0.8 \qquad ( 8 )$$

$$0.5 < TL / ( f \times tan ω ) < 10 \qquad ( 9 )$$

Here, symbols of the conditional expressions are defined as follows. A focal length of the imaging optical system is denoted by f. An F-number of the imaging optical system is denoted by FNo. A maximum half angle of view of the imaging optical system is denoted by ω.

In a case where a lens having a maximum refractive index with respect to a d line among lenses included in the imaging optical system is denoted by an LNdmax lens, the imaging apparatus of the aspect preferably satisfies Conditional Expressions (10) and (11) below.

$$1 \text{.7} < Ndm < 2.15 \qquad ( 10 )$$

$$1.95 < N d m + 0.01 \times v d m < 2.4 \qquad ( 11 )$$

Here, symbols of the conditional expressions are defined as follows. The refractive index of the LNdmax lens with respect to the d line is denoted by Ndm. An Abbe number of the LNdmax lens based on the d line is denoted by vdm.

In a case where a maximum value of absolute values of temperature coefficients of refractive indexes of all lenses included in the imaging optical system with respect to a d line within a temperature range of 20° C. to 40° C. is denoted by |(dN/dT)m|×10⁻⁶, the imaging apparatus of the aspect preferably satisfies Conditional Expression (12) below. A unit of |(dN/dT)m|×10⁻⁶ is denoted by ° C.⁻¹.

$$0 < \vert ( dN / dT ) m \vert < 12 \qquad ( 12 )$$

The imaging apparatus of the aspect preferably satisfies Conditional Expression (13) below.

$$- 0.8 < TL / Ri < - 0 \text{.02} \qquad ( 13 )$$

In a case where an effective diameter of the lens surface of the imaging optical system closest to the image side is denoted by EDr, the imaging apparatus of the aspect preferably satisfies Conditional Expression (14) below.

$$0.3 < EDf / EDr < 5 \qquad ( 14 )$$

The imaging apparatus of the aspect preferably satisfies at least one of Conditional Expressions (15), (16), or (17) below.

$$0.2 < Ltot / f < 6 \qquad ( 15 )$$

$$0.6 < ( Ltot / f ) \times FNo < 15 \qquad ( 16 )$$

$$0.45 < Ltot / ( f \times tan ω ) < 6 \qquad ( 17 )$$

Here, symbols of the conditional expressions are defined as follows. A distance on the optical axis from the lens surface of the imaging optical system closest to the object side to the lens surface of the imaging optical system closest to the image side is denoted by Ltot. A focal length of the imaging optical system is denoted by f. An F-number of the imaging optical system is denoted by FNo. A maximum half angle of view of the imaging optical system is denoted by ω.

In the imaging apparatus of the aspect, the lens surface of the imaging optical system closest to the image side preferably has a convex shape.

In a configuration in which the imaging optical system of the imaging apparatus of the aspect includes an aperture stop, the imaging apparatus of the aspect preferably satisfies at least one of Conditional Expressions (18), (19), or (20) below.

$$0.01 < f / ff < 1.3 \qquad ( 18 )$$

$$0.1 < f / fr < 1.5 \qquad ( 19 )$$

$$0.1 < L 1 ST / Ltot < 0.9 \qquad ( 20 )$$

Here, symbols of the conditional expressions are defined as follows. A focal length of the imaging optical system is denoted by f. A combined focal length of all lenses in the imaging optical system closer to the object side than the aperture stop is denoted by ff. A combined focal length of all lenses in the imaging optical system closer to the image side than the aperture stop is denoted by fr. A distance on the optical axis from the lens surface of the imaging optical system closest to the object side to the aperture stop is denoted by L1ST. A distance on the optical axis from the lens surface of the imaging optical system closest to the object side to the lens surface of the imaging optical system closest to the image side is denoted by Ltot.

In the present specification, the expressions “consists of” and “consisting of” intend that a lens substantially not having a refractive power, an optical element other than a lens such as a stop, a filter, and a cover glass, a mechanism part such as a lens flange, a lens barrel, an imaging element, and a camera shake correction mechanism may be included in addition to the illustrated constituents.

Unless otherwise specified, a curvature radius, a sign of a refractive power, and a surface shape related to a lens including an aspherical surface in a paraxial region are used. For a sign of the curvature radius, a sign of the curvature radius of a surface having a convex shape toward the object side is positive, and a sign of the curvature radius of a surface having a convex shape toward the image side is negative. A compound aspherical lens (a lens (for example, a spherical lens) and a film of an aspherical shape formed on the lens are configured to be integrated with each other, and the lens functions as one aspherical lens as a whole) is not considered to be a cemented lens and is regarded as one lens.

The term “focal length” used in the conditional expressions is a paraxial focal length. Unless otherwise specified, the term “distance on the optical axis” used in the conditional expressions is a geometrical distance. Unless otherwise specified, values used in the conditional expressions are values based on the d line in a state where an infinite distance object is focused on.

According to the present disclosure, an imaging apparatus having a small size and favorable performance can be provided.

### BRIEF DESCRIPTION OF THE DRAWINGS

FIG. 1 is a schematic perspective view of a front surface side of an imaging apparatus according to one embodiment.

FIG. 2 is a cross-sectional view that corresponds to an imaging optical system and an imaging surface of Example 1 and that illustrates a configuration of a main part of the imaging apparatus according to one embodiment.

FIG. 3 is a cross-sectional view illustrating luminous fluxes in the imaging optical system in FIG. 2.

FIG. 4 is a diagram for describing an effective diameter.

FIG. 5 is each aberration diagram of Example 1.

FIG. 6 is a cross-sectional view illustrating a configuration and luminous fluxes of an imaging optical system of Example 2.

FIG. 7 is each aberration diagram of Example 2.

FIG. 8 is a cross-sectional view illustrating a configuration and luminous fluxes of an imaging optical system of Example 3.

FIG. 9 is each aberration diagram of Example 3.

FIG. 10 is a cross-sectional view illustrating a configuration and luminous fluxes of an imaging optical system of Example 4.

FIG. 11 is each aberration diagram of Example 4.

FIG. 12 is a cross-sectional view illustrating a configuration and luminous fluxes of an imaging optical system of Example 5.

FIG. 13 is each aberration diagram of Example 5.

### DESCRIPTION OF EMBODIMENTS

Hereinafter, an embodiment of the present disclosure will be described with reference to the drawings.

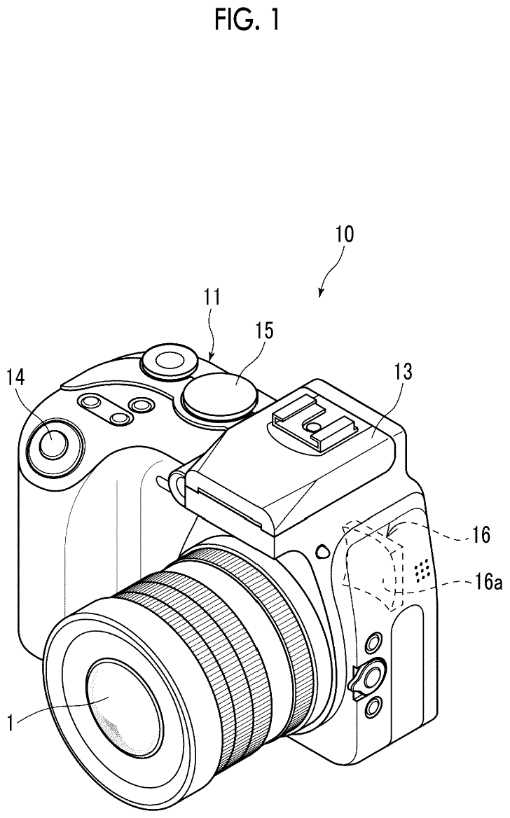

FIG. 1 illustrates a schematic perspective view of a front surface side of an imaging apparatus 10 according to one embodiment of the present disclosure. The imaging apparatus 10 in FIG. 1 is a digital camera and comprises a camera body 11 and an imaging optical system 1 mounted on a front side of the camera body 11. The imaging optical system 1 includes a plurality of lenses. The imaging optical system I may be configured to be integrated with the camera body 11 or may be configured to be attachably and detachably mounted on the camera body 11. A flash light emitting device 13, a shutter button 14, and a mode dial 15 are provided on an upper side of the camera body 11.

The camera body 11 comprises an imaging element 16 in its inside. The imaging element 16 captures an optical image formed by the imaging optical system 1 and outputs an imaging signal corresponding to the optical image. For example, a charge coupled device (CCD) or a complementary metal oxide semiconductor (CMOS) can be used as the imaging element 16. An imaging surface 16a of the imaging element 16 is disposed at an image forming position of the imaging optical system 1 and has a curved shape having a concave surface toward an object side. By forming the imaging surface 16a to have such a shape, a load in correcting a field curvature in the imaging optical system 1 can be reduced. Thus, an advantage of size reduction is achieved. The expression “disposed at the image forming position” is assumed to include an error range generally allowed in the technical field. The curved shape of the imaging surface 16a may be a spherical shape or an aspherical shape.

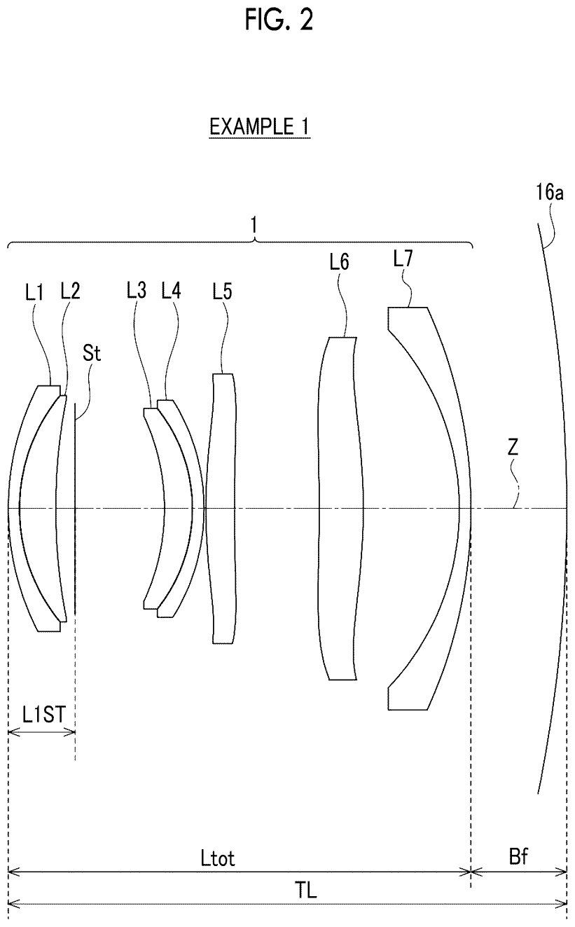

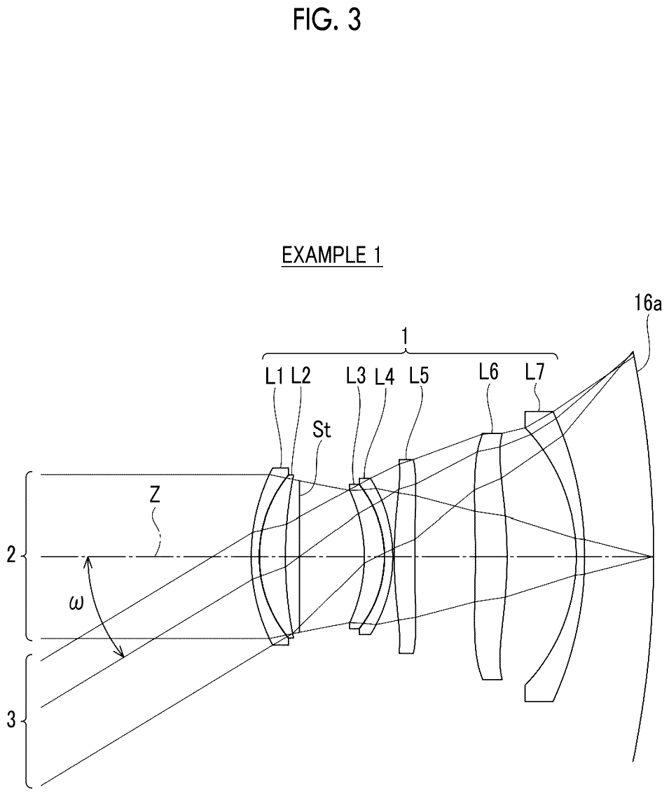

FIG. 2 illustrates an example of configurations of the imaging optical system 1 and the imaging surface 16a which are main parts of the imaging apparatus 10. FIG. 2 is a diagram of a cross section including an optical axis Z of the imaging optical system 1, in which a left side is the object side and a right side is an image side. A position of the imaging surface 16a matches the image forming position of the imaging optical system 1 on the optical axis. FIG. 3 illustrates an on-axis luminous flux 2 and a luminous flux 3 with a maximum half angle of view ω in a state where the imaging optical system 1 in FIG. 2 is focused on an infinite distance object. The examples illustrated in FIGS. 2 and 3 correspond to Example 1 described later. Hereinafter, description will be mainly provided with reference to FIG. 2.

For example, the imaging optical system 1 in FIG. 2 is a single focus optical system and consists of lenses L1 and L2, an aperture stop St, and lenses L3 to L7 in this order from the object side to the image side. The aperture stop St in FIG. 2 does not indicate a size and a shape and indicates a position in an optical axis direction.

A lens surface of the imaging optical system 1 closest to the image side preferably has a convex shape. In this case, an advantage of correcting the field curvature is achieved.

It may be configured that the lens surface of the imaging optical system 1 closest to the image side has a convex shape, and a lens surface of the imaging optical system 1 closest to the object side has a convex shape. In this case, an advantage of suppressing various aberrations caused by off-axis rays is achieved.

The imaging optical system 1 may be configured to include the aperture stop St, a first cemented lens positioned closer to the object side than the aperture stop St, and a second cemented lens positioned closer to the image side than the aperture stop St, in which one of a bonding surface of the first cemented lens and a bonding surface of the second cemented lens has a convex shape toward the object side, and the other has a convex shape toward the image side. In this case, an advantage of suppressing various aberrations caused by off-axis rays is achieved.

Hereinafter, preferable configurations related to conditional expressions will be described. In the following description of the conditional expressions, in order to avoid redundancy, duplicate descriptions of symbols will be omitted by using the same symbol for the same definition.

The imaging apparatus 10 preferably satisfies Conditional Expression (1) below. Here, a back focus of the imaging optical system 1 as an air conversion distance is denoted by Bf. A curvature radius of the imaging surface 16a is denoted by Ri. By not causing a corresponding value of Conditional Expression (1) to be less than or equal to its lower limit, an absolute value of the curvature radius of the imaging surface 16a is not excessively decreased. Thus, an advantage of obtaining an effect of size reduction with the curved imaging surface 16a is achieved. By not causing the corresponding value of Conditional Expression (1) to be greater than or equal to its upper limit, the back focus Bf is not excessively increased. Thus, an incidence angle of an off-axis main ray on the imaging surface 16a is not excessively decreased, and an advantage of obtaining the effect of size reduction with the curved imaging surface 16a is achieved.

$$- 0.3 < Bf / Ri < - 0.005 \qquad ( 1 )$$

The term “back focus of the imaging optical system 1 as the air conversion distance” means an air conversion distance on the optical axis from the lens surface of the imaging optical system 1 closest to the image side to the image forming position. For example, FIG. 2 illustrates the back focus Bf. In a case where the imaging surface 16a has an aspherical shape, a circle connecting three points including a center of the imaging surface 16a and both ends of the longest diameter of the imaging surface 16a is drawn, and a curvature radius of the circle will be denoted by Ri. In a case where the shape of the imaging surface 16a in a plane perpendicular to the optical axis Z is a rectangle, the term “both ends of the longest diameter of the imaging surface 16a” means both ends of the imaging surface 16a on a diagonal.

In order to obtain more favorable characteristics, it is preferable to set the lower limit of Conditional Expression (1) to any of −0.26, −0.22, −0.18, and −0.14 instead of −0.3. In addition, it is preferable to set the upper limit of Conditional Expression (1) to any of −0.01, −0.02, −0.03, −0.04, and −0.05 instead of −0.005.

The imaging apparatus 10 preferably satisfies Conditional Expression (2) below. Here, a paraxial curvature radius of the lens surface of the imaging optical system 1 closest to the image side is denoted by Rr. By not causing a corresponding value of Conditional Expression (2) to be less than or equal to its lower limit, the absolute value of the curvature radius of the imaging surface 16a is not excessively decreased. Thus, an advantage of obtaining the effect of size reduction with the curved imaging surface 16a is achieved. By not causing the corresponding value of Conditional Expression (2) to be greater than or equal to its upper limit, the absolute value of the curvature radius of the imaging surface 16a is not excessively increased. Thus, an increase in a lattice defect, an increase in a dark current, and an increase in noise in the imaging element 16 can be suppressed. Accordingly, an advantage of establishing both of high image quality and size reduction is achieved.

$$- 5 < ( Rr + Ri ) / ( Rr - Ri ) < - 0.1 \qquad ( 2 )$$

In order to obtain more favorable characteristics, it is preferable to set the lower limit of Conditional Expression (2) to any of −4, −3, and −2.5 instead of −5. In addition, it is preferable to set the upper limit of Conditional Expression (2) to any of −0.3, −0.5, −0.7, −0.8, and −0.9 instead of −0.1.

The imaging apparatus 10 preferably satisfies Conditional Expression (3) below. Here, an effective diameter of the lens surface of the imaging optical system 1 closest to the object side is denoted by EDf. A sum of a distance on the optical axis from the lens surface of the imaging optical system 1 closest to the object side to the lens surface of the imaging optical system I closest to the image side and the back focus Bf is denoted by TL. TL is a so-called total optical length. For example, FIG. 2 illustrates the total optical length TL. By not causing a corresponding value of Conditional Expression (3) to be less than or equal to its lower limit, the total optical length TL is not excessively increased. Thus, an advantage of size reduction is achieved. By not causing the corresponding value of Conditional Expression (3) to be greater than or equal to its upper limit, the effective diameter of the lens surface of the imaging optical system 1 closest to the object side is not excessively increased. Thus, an advantage of size reduction is achieved.

$$0.1 < EDf / TL < 0.8 \qquad ( 3 )$$

In order to obtain more favorable characteristics, it is preferable to set the lower limit of Conditional Expression (3) to any of 0.15, 0.2, 0.25, 0.3, and 0.35 instead of 0.1. In addition, it is preferable to set the upper limit of Conditional Expression (3) to any of 0.75, 0.7, 0.65, 0.6, and 0.55 instead of 0.8.

In the present specification, it is assumed that among rays that are incident on a lens surface from the object side and that are emitted to the image side, double a distance from an intersection between the lens surface and a ray passing through the outermost side of the lens surface to the optical axis Z is the “effective diameter” of the lens surface. Here, the term “outer side” means an outer side in a diameter direction centered on the optical axis Z, that is, a side of separating from the optical axis Z.

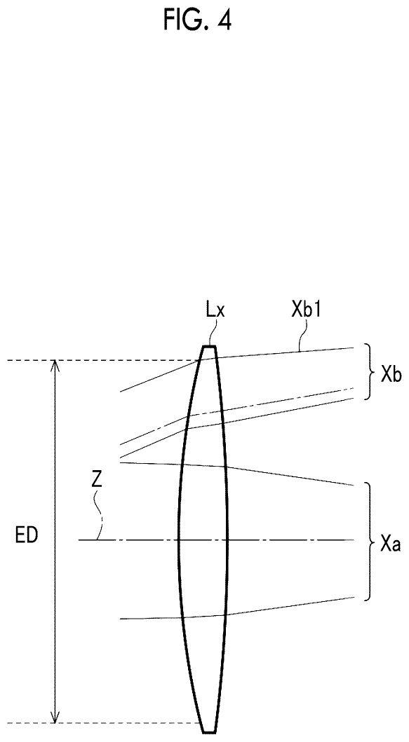

FIG. 4 illustrates an example of the effective diameter ED as a diagram for description. In FIG. 4, a left side is the object side, and a right side is the image side. FIG. 4 illustrates an on-axis luminous flux Xa and an off-axis luminous flux Xb passing through a lens Lx. In the example in FIG. 4, a ray Xb1 that is an upper ray of the off-axis luminous flux Xb is the ray passing through the outermost side. Thus, in the example in FIG. 4, double a distance from an intersection between a surface of the lens Lx on the object side and the ray Xb1 to the optical axis Z is the effective diameter ED of the surface of the lens Lx on the object side. While the upper ray of the off-axis luminous flux Xb is the ray passing through the outermost side in FIG. 4, which ray is the ray passing through the outermost side varies depending on the optical system.

In a case where a focal length of the imaging optical system 1 is denoted by f, the imaging apparatus 10 preferably satisfies Conditional Expression (4) below. By not causing a corresponding value of Conditional Expression (4) to be less than or equal to its lower limit, a refractive power of each lens included in the imaging optical system 1 is not excessively increased. Thus, an advantage of suppressing a spherical aberration is achieved. By not causing the corresponding value of Conditional Expression (4) to be greater than or equal to its upper limit, an advantage of size reduction is achieved.

$$0.3 < TL / f < 9 \qquad ( 4 )$$

In order to obtain more favorable characteristics, it is preferable to set the lower limit of Conditional Expression (4) to any of 0.4, 0.5, 0.6, 0.7, and 0.8 instead of 0.3. In addition, it is preferable to set the upper limit of Conditional Expression (4) to any of 7.5, 6.5, 4.5, 3, and 2 instead of 9.

In a case where an F-number of the imaging optical system 1 is denoted by FNo, the imaging apparatus 10 preferably satisfies Conditional Expression (5) below. In a case where the F-number can be changed, an open F-number will be denoted by FNo. By not causing a corresponding value of Conditional Expression (5) to be less than or equal to its lower limit, the refractive power of each lens included in the imaging optical system 1 is not excessively increased. Thus, an advantage of suppressing the spherical aberration is achieved. By not causing the corresponding value of Conditional Expression (5) to be greater than or equal to its upper limit, an advantage of size reduction or an advantage of implementing the imaging apparatus 10 having a small F-number is achieved.

$$0.5 < ( TL / f ) \times FNo < 23 \qquad ( 5 )$$

In order to obtain more favorable characteristics, it is preferable to set the lower limit of Conditional Expression (5) to any of 0.8, 1.1, 1.4, 1.7, and 2 instead of 0.5. In addition, it is preferable to set the upper limit of Conditional Expression (5) to any of 21, 19, 15, and 11 instead of 23.

The imaging apparatus 10 preferably satisfies Conditional Expression (6) below. Here, the maximum half angle of view of the imaging optical system 1 is denoted by ω. In Conditional Expression (6), tan is a tangent, and the same representation applies to other conditional expressions. By not causing a corresponding value of Conditional Expression (6) to be less than or equal to its lower limit, an advantage of high performance is achieved. By not causing the corresponding value of Conditional Expression (6) to be greater than or equal to its upper limit, an increase in a diameter of a lens of the imaging optical system 1 closest to the object side can be suppressed. Thus, an advantage of size reduction is achieved.

$$0.3 < EDf / ( f \times tan ω ) < 5 \qquad ( 6 )$$

In order to obtain more favorable characteristics, it is preferable to set the lower limit of Conditional Expression (6) to any of 0.4, 0.5, and 0.6 instead of 0.3. In addition, it is preferable to set the upper limit of Conditional Expression (6) to any of 4.5, 4, 3.5, 3, and 2.5 instead of 5.

The imaging apparatus 10 preferably satisfies Conditional Expression (7) below. By not causing a corresponding value of Conditional Expression (7) to be less than or equal to its lower limit, an image height is not excessively increased. Thus, an advantage of obtaining the effect of size reduction with the curved imaging surface 16a is achieved. By not causing the corresponding value of Conditional Expression (7) to be greater than or equal to its upper limit, the back focus Bf is not excessively increased. Thus, the incidence angle of the off-axis main ray on the imaging surface 16a is not excessively decreased, and an advantage of obtaining the effect of size reduction with the curved imaging surface 16a is achieved.

$$0.1 < Bf / ( f \times tan ω ) < 5 \qquad ( 7 )$$

In order to obtain more favorable characteristics, it is preferable to set the lower limit of Conditional Expression (7) to any of 0.18, 0.24, and 0.3 instead of 0.1. In addition, it is preferable to set the upper limit of Conditional Expression (7) to any of 4.5, 4, 3.5, 3, and 2.5 instead of 5.

The imaging apparatus 10 preferably satisfies Conditional Expression (8) below. By not causing a corresponding value of Conditional Expression (8) to be less than or equal to its lower limit, the total optical length TL is not excessively increased. Thus, an advantage of size reduction is achieved. By not causing the corresponding value of Conditional Expression (8) to be greater than or equal to its upper limit, the back focus Bf is not excessively increased. Thus, the incidence angle of the off-axis main ray on the imaging surface 16a is not excessively decreased, and an advantage of obtaining the effect of size reduction with the curved imaging surface 16a is achieved.

$$0.1 < Bf / TL < 0.8 \qquad ( 8 )$$

In order to obtain more favorable characteristics, it is preferable to set the lower limit of Conditional Expression (8) to any of 0.13, 0.16, 0.19, 0.22, and 0.25 instead of 0.1. In addition, it is preferable to set the upper limit of Conditional Expression (8) to any of 0.76, 0.71, 0.66, 0.61, and 0.57 instead of 0.8.

The imaging apparatus 10 preferably satisfies Conditional Expression (9) below. By not causing a corresponding value of Conditional Expression (9) to be less than or equal to its lower limit, an advantage of suppressing various aberrations caused by off-axis rays is achieved. By not causing the corresponding value of Conditional Expression (9) to be greater than or equal to its upper limit, an advantage of size reduction of the entire imaging optical system is achieved.

$$0.5 < TL / ( f \times tan ω ) < 10 \qquad ( 9 )$$

In order to obtain more favorable characteristics, it is preferable to set the lower limit of Conditional Expression (9) to any of 0.75 and 1 instead of 0.5. In addition, it is preferable to set the upper limit of Conditional Expression (9) to any of 9, 8, 7, 6, and 5 instead of 10.

The imaging apparatus 10 preferably satisfies Conditional Expression (10) below. Here, a lens having the maximum refractive index with respect to a d line among the lenses included in the imaging optical system 1 is denoted by an LNdmax lens, and the refractive index of the LNdmax lens with respect to the d line is denoted by Ndm. By not causing a corresponding value of Conditional Expression (10) to be less than or equal to its lower limit, an advantage of reducing the total optical length TL is achieved. By not causing the corresponding value of Conditional Expression (10) to be greater than or equal to its upper limit, a specific gravity of a material of the lens is not excessively increased. Thus, an advantage of size and weight reduction is achieved. In the example in FIG. 2, the lens L7 corresponds to the LNdmax lens.

$$1.7 < Ndm < 2.15 \qquad ( 10 )$$

In order to obtain more favorable characteristics, it is preferable to set the lower limit of Conditional Expression (10) to any of 1.75, 1.79, 1.81, and 1.84 instead of 1.7. In addition, it is preferable to set the upper limit of Conditional Expression (10) to any of 2.08, 2.02, 1.97, and 1.93 instead of 2.15.

The imaging apparatus 10 preferably satisfies Conditional Expression (11) below. Here, an Abbe number of the LNdmax lens based on the d line is denoted by vdm. By not causing a corresponding value of Conditional Expression (11) to be less than or equal to its lower limit, an advantage of reducing the total optical length TL is achieved. By not causing the corresponding value of Conditional Expression (11) to be greater than or equal to its upper limit, an advantage of high performance is achieved. Particularly, an advantage of correcting a second-order chromatic aberration is achieved.

$$1.95 < Ndm + 0.01 \times vdm < 2.4 \qquad ( 11 )$$

In order to obtain more favorable characteristics, it is preferable to set the lower limit of Conditional Expression (11) to any of 1.98, 2.01, 2.04, 2.07, and 2.1 instead of 1.95. In addition, it is preferable to set the upper limit of Conditional Expression (11) to any of 2.37, 2.34, 2.31, 2.29, and 2.25 instead of 2.4.

In order to obtain more favorable characteristics, the imaging optical system 1 more preferably satisfies Conditional Expressions (10) and (11) at the same time.

The imaging apparatus 10 preferably satisfies Conditional Expression (12) below. Here, a maximum value of absolute values of temperature coefficients of refractive indexes of all lenses included in the imaging optical system 1 with respect to the d line within a temperature range of 20° C. to 40° C. is denoted by |(dN/dT)m|×10⁻⁶. A unit of |(dN/dT)m|×10⁻⁶ is denoted by ° C.⁻¹. By not causing a corresponding value of Conditional Expression (12) to be greater than or equal to its upper limit, an advantage of reducing fluctuations of the image forming position under a temperature change is achieved.

$$0 < \vert ( dN / dT ) m \vert < 12 \qquad ( 12 )$$

In order to obtain more favorable characteristics, it is preferable to set the upper limit of Conditional Expression (12) to any of 10.5, 9, 7.6, 7.1, and 6.5 instead of 12.

The imaging apparatus 10 preferably satisfies Conditional Expression (13) below. By not causing a corresponding value of Conditional Expression (13) to be less than or equal to its lower limit, the total optical length TL is not excessively increased. Thus, an advantage of size reduction is achieved. By not causing the corresponding value of Conditional Expression (13) to be greater than or equal to its upper limit, the absolute value of the curvature radius of the imaging surface 16a is not excessively decreased. Thus, an advantage of obtaining the effect of size reduction with the curved imaging surface 16a is achieved.

$$- 0.8 < TL / Ri < - 0.02 \qquad ( 13 )$$

In order to obtain more favorable characteristics, it is preferable to set the lower limit of Conditional Expression (13) to any of −0.7, −0.6, −0.55, −0.5, and −0.45 instead of −0.8. In addition, it is preferable to set the upper limit of Conditional Expression (13) to any of −0.05, −0.08, −0.11, −0.14, and −0.17 instead of 0.02.

The imaging apparatus 10 preferably satisfies Conditional Expression (14) below. Here, an effective diameter of the lens surface of the imaging optical system 1 closest to the image side is denoted by EDr. By not causing a corresponding value of Conditional Expression (14) to be less than or equal to its lower limit, the effective diameter of the lens surface of the imaging optical system 1 closest to the image side is not excessively increased. Thus, an advantage of size reduction is achieved. By not causing the corresponding value of Conditional Expression (14) to be greater than or equal to its upper limit, the effective diameter of the lens surface of the imaging optical system 1 closest to the object side is not excessively increased. Thus, an advantage of size reduction is achieved.

$$0.3 < EDf / EDr < 5 \qquad ( 14 )$$

In order to obtain more favorable characteristics, it is preferable to set the lower limit of Conditional Expression (14) to any of 0.4, 0.5, 0.6, 0.7, and 0.8 instead of 0.3. In addition, it is preferable to set the upper limit of Conditional Expression (14) to any of 4.5, 4, 3.5, 2.8, and 2.1 instead of 5.

The imaging apparatus 10 preferably satisfies Conditional Expression (15) below. Here, a distance on the optical axis from the lens surface of the imaging optical system 1 closest to the object side to the lens surface of the imaging optical system 1 closest to the image side is denoted by Ltot. For example, FIG. 2 illustrates the distance Ltot. By not causing a corresponding value of Conditional Expression (15) to be less than or equal to its lower limit, the refractive power of each lens included in the imaging optical system 1 is not excessively increased. Thus, an advantage of suppressing the spherical aberration is achieved. By not causing the corresponding value of Conditional Expression (15) to be greater than or equal to its upper limit, an advantage of size reduction is achieved.

$$0.2 < Ltot / f < 6 \qquad ( 15 )$$

In order to obtain more favorable characteristics, it is preferable to set the lower limit of Conditional Expression (15) to any of 0.25, 0.3, 0.35, 0.4, and 0.45 instead of 0.2. In addition, it is preferable to set the upper limit of Conditional Expression (15) to any of 5, 4, 3, 2.2, and 1.1 instead of 6.

The imaging apparatus 10 preferably satisfies Conditional Expression (16) below. By not causing a corresponding value of Conditional Expression (16) to be less than or equal to its lower limit, the refractive power of each lens included in the imaging optical system 1 is not excessively increased. Thus, an advantage of suppressing the spherical aberration is achieved. By not causing the corresponding value of Conditional Expression (16) to be greater than or equal to its upper limit, an advantage of size reduction or an advantage of implementing the imaging apparatus 10 having a small F-number is achieved.

$$0.6 < ( Ltot / f ) \times FNo < 15 \qquad ( 16 )$$

In order to obtain more favorable characteristics, it is preferable to set the lower limit of Conditional Expression (16) to any of 0.7, 0.8, 0.9, 1, and 1.1 instead of 0.6. In addition, it is preferable to set the upper limit of Conditional Expression (16) to any of 10, 5, 4, 3.3, and 2.6 instead of 15.

The imaging apparatus 10 preferably satisfies Conditional Expression (17) below. By not causing a corresponding value of Conditional Expression (17) to be less than or equal to its lower limit, an advantage of suppressing various aberrations caused by off-axis rays is achieved. By not causing the corresponding value of Conditional Expression (17) to be greater than or equal to its upper limit, an advantage of size reduction of the entire imaging optical system is achieved.

$$0.45 < Ltot / ( f \times tan ω ) < 6 \qquad ( 17 )$$

In order to obtain more favorable characteristics, it is preferable to set the lower limit of Conditional Expression (17) to any of 0.55, 0.65, 0.75, 0.85, and 0.95 instead of 0.45. In addition, it is preferable to set the upper limit of Conditional Expression (17) to any of 5.3, 4.7, 4.1, 3.5, and 2.9 instead of 6.

In the configuration in which the imaging optical system 1 includes the aperture stop St, the imaging apparatus 10 preferably satisfies Conditional Expression (18) below. Here, a combined focal length of all lenses in the imaging optical system closer to the object side than the aperture stop St is denoted by ff. By not causing a corresponding value of Conditional Expression (18) to be less than or equal to its lower limit, a positive refractive power of a group consisting of all lenses in the imaging optical system closer to the object side than the aperture stop St is not excessively decreased. Thus, since an increase in the total optical length TL can be suppressed, an advantage of size reduction is achieved. By not causing the corresponding value of Conditional Expression (18) to be greater than or equal to its upper limit, the positive refractive power of the group consisting of all lenses in the imaging optical system closer to the object side than the aperture stop St is not excessively increased. Thus, an advantage of correcting the spherical aberration and the field curvature is achieved.

$$0.01 < f / ff < 1.3 \qquad ( 18 )$$

In order to obtain more favorable characteristics, it is preferable to set the lower limit of Conditional Expression (18) to any of 0.02, 0.05, 0.1, 0.15, and 0.2 instead of 0.01. In addition, it is preferable to set the upper limit of Conditional Expression (18) to any of 1.2, 1.1, 1, 0.9, and 0.8 instead of 1.3.

In the configuration in which the imaging optical system 1 includes the aperture stop St, the imaging apparatus 10 preferably satisfies Conditional Expression (19) below. Here, a combined focal length of all lenses in the imaging optical system closer to the image side than the aperture stop St is denoted by fr. By not causing a corresponding value of Conditional Expression (19) to be less than or equal to its lower limit, a positive refractive power of a group consisting of all lenses in the imaging optical system closer to the image side than the aperture stop St is not excessively decreased. Accordingly, an increase in the total optical length TL can be suppressed, and an advantage of further correcting the spherical aberration is achieved. By not causing the corresponding value of Conditional Expression (19) to be greater than or equal to its upper limit, the positive refractive power of the group consisting of all lenses in the imaging optical system closer to the image side than the aperture stop St is not excessively increased. Thus, excessive correction of the spherical aberration can be suppressed.

$$0.1 < f / fr < 1.5 \qquad ( 19 )$$

In order to obtain more favorable characteristics, it is preferable to set the lower limit of Conditional Expression (19) to any of 0.12, 0.14, 0.16, 0.18, and 0.19 instead of 0.1. In addition, it is preferable to set the upper limit of Conditional Expression (19) to any of 1.4, 1.3, 1.2, 1.1, and 1 instead of 1.5.

In the configuration in which the imaging optical system 1 includes the aperture stop St, the imaging apparatus 10 preferably satisfies Conditional Expression (20) below. Here, a distance on the optical axis from the lens surface of the imaging optical system I closest to the object side to the aperture stop St is denoted by L1ST. For example, FIG. 2 illustrates the distance L1ST. By not causing a corresponding value of Conditional Expression (20) to be less than or equal to its lower limit, a space closer to the object side than the aperture stop St can be sufficiently secured. Thus, the imaging optical system I can be composed of an appropriate number of lenses without excessively decreasing absolute values of curvature radiuses of the lenses. Accordingly, an advantage of suitably correcting various aberrations is achieved. By not causing the corresponding value of Conditional Expression (20) to be greater than or equal to its upper limit, a position of the aperture stop St is not excessively brought close to the imaging element 16. Thus, an excessive increase in the incidence angle of the off-axis main ray on the imaging surface 16a can be prevented.

$$0.1 < L 1 ST / Ltot < 0.9 \qquad ( 20 )$$

In order to obtain more favorable characteristics, it is preferable to set the lower limit of Conditional Expression (20) to any of 0.14, 0.16, 0.2, 0.22, and 0.25 instead of 0.1. In addition, it is preferable to set the upper limit of Conditional Expression (20) to any of 0.85, 0.8, 0.75, 0.7, and 0.65 instead of 0.9.

The example illustrated in FIG. 2 is merely an example, and various modifications can be made without departing from the gist of the disclosed technology. For example, in the disclosed technology, configurations of the lenses and the number of lenses included in the imaging optical system may be different from those in the example in FIG. 2.

The above preferable configurations and available configurations can be combined with each other in any manner and are preferably employed appropriately selectively in accordance with required specifications.

For example, one preferable aspect of the imaging apparatus according to the embodiment of the present disclosure is an imaging apparatus comprising an imaging optical system including a plurality of lenses, and a curved imaging surface that is disposed at an image forming position of the imaging optical system and that has a concave surface toward an object side, in which Conditional Expressions (1), (2), and (3) are satisfied.

Next, examples of the imaging apparatus according to the embodiment of the present disclosure will be described with reference to the drawings. In the following description of the examples, the imaging optical system 1 and the imaging surface 16a which are main parts of the imaging apparatus are described, and the drawings of the examples illustrate cross-sectional views of the imaging optical system 1 and the imaging surface 16a together with their luminous fluxes. Reference numerals provided in the cross-sectional view of each example are independently used for each example in order to avoid complication of description and the drawings caused by an increase in the number of digits of the reference numerals. Accordingly, even in a case where a common reference numeral is provided in the drawings of different examples, the common reference numeral does not necessarily indicate a common configuration.

### Example 1

The cross-sectional view and the luminous fluxes of Example 1 are illustrated in FIG. 3, and their illustration method and their configurations are described above. Thus, duplicate descriptions will be partially omitted. The imaging optical system 1 of Example 1 consists of the lenses L1 and L2, the aperture stop St, and the lenses L3 to L7 in this order from the object side to the image side. The imaging surface 16a of Example 1 has a curved shape having a concave surface toward the object side.

For Example 1, basic lens data is shown in Table 1, specifications are shown in Table 2, and aspherical coefficients are shown in Table 3.

The table of the basic lens data is described as follows. A column of “Sn” shows surface numbers in a case where the number is increased by one at a time toward the image side from the surface closest to the object side as a first surface. A column of “R” shows a curvature radius of each surface. A column of “D” shows a surface spacing on the optical axis between each surface and its adjacent surface on the image side. A column of “Nd” shows a refractive index of each constituent with respect to the d line. A column of “vd” shows an Abbe number of each constituent based on the d line. A column of “θgF” shows a partial dispersion ratio of each constituent between a g line and an F line. A column of “dN/dT” shows a value obtained by multiplying a temperature coefficient of the refractive index of each constituent with respect to the d line within a temperature range of 20° C. to 40° C. by 10⁶. A unit of the temperature coefficient is denoted by ° C.⁻¹. A column of “ED” shows an effective diameter of each surface.

In a case where refractive indexes of a lens with respect to the g line, the F line, and a C line are denoted by Ng, NF, and NC, respectively, and a partial dispersion ratio of the lens between the g line and the F line is denoted by θgF, θgF is defined as the following expression.

$$θ gF = ( Ng - NF ) / ( NF - NC )$$

The terms “d line”, “C line”, “F line”, and “g line” described in the present specification mean bright lines. A wavelength of the d line is 587.56 nanometers (nm). A wavelength of the C line is 656.27 nanometers (nm). A wavelength of the F line is 486.13 nanometers (nm). A wavelength of the g line is 435.84 nanometers (nm).

In the table of the basic lens data, a sign of the curvature radius of the surface having a convex shape toward the object side is positive, and a sign of the curvature radius of the surface having a convex shape toward the image side is negative. A field of the surface number of the surface corresponding to the aperture stop St has the surface number and a text (St). A field of the surface number of the surface corresponding to the imaging surface 16a has a text “Simg”.

In the table of the specifications, the focal length f, the back focus Bf, an F-number FNo., and a maximum full angle of view 2ω of the imaging optical system 1 are shown based on the d line. In a field of the maximum full angle of view, [°] indicates a degree unit. FNo. in the table of the specifications has the same definition as FNo in the conditional expressions.

In the basic lens data, surface numbers of aspherical surfaces are marked with *, and values of paraxial curvature radiuses are described in fields of the curvature radiuses of the aspherical surfaces. In Table 3, the column of Sn shows the surface numbers of the aspherical surfaces, and columns of KA and Am show numerical values of the aspherical coefficients for each aspherical surface. Here, m of Am is an integer greater than or equal to 3 and varies depending on the surface. For example, for the eighth surface of Example 1, m=3, 4, 5, . . . , 20 is established. In the numerical values of the aspherical coefficients in Table 3, “E±n” (n: integer) means “×10^{±n}”. KA and Am are aspherical coefficients in an aspheric equation represented by the following expression.

$$Zd = C \times {h}^{2} / \{ 1 + {( 1 - KA \times {C}^{2} \times {h}^{2} )}^{1 / 2} \} + Σ Am \times {h}^{m}$$

where
Zd: a depth of an aspherical surface (a length of a perpendicular line drawn from a point on the aspherical surface having a height h to a plane that is in contact with an aspherical surface apex and that is perpendicular to the optical axis Z)
h: a height (a distance from the optical axis Z to the lens surface)
C: a reciprocal of the paraxial curvature radius
KA and Am: aspherical coefficients
Σ in the aspheric equation means a total sum with respect to m.

In the data of each table, a degree unit is used for angles, and a millimeter unit is used for lengths. However, since the optical system can also be proportionally enlarged or proportionally reduced to be used, other appropriate units can also be used. In addition, numerical values rounded to predetermined digits are described in each table shown below.

TABLE 1
Example 1

| Sn | R | D | Nd | νd | θgF | dN/dT | ED |
|---|---|---|---|---|---|---|---|
| 1 | 13.15661 | 0.580 | 1.80518 | 25.46 | 0.61572 | 0.9 | 12.33 |
| 2 | 8.71802 | 1.870 | 1.75500 | 52.32 | 0.54737 | 4.1 | 11.34 |
| 3 | 27.89000 | 0.998 | | | | | 11.07 |
| 4 (St) | ∞ | 4.618 | | | | | 10.56 |
| 5 | −10.58693 | 1.437 | 1.51742 | 52.43 | 0.55649 | 1.8 | 9.29 |
| 6 | −7.86235 | 0.600 | 1.66755 | 41.96 | 0.57417 | 3.2 | 10.02 |
| 7 | −10.00256 | 0.100 | | | | | 10.89 |
| *8 | 28.77230 | 1.479 | 1.65160 | 58.54 | 0.53901 | 3.8 | 12.86 |
| *9 | 124.51819 | 4.335 | | | | | 13.51 |
| *10 | −86.49367 | 2.279 | 1.59551 | 39.24 | 0.58043 | 1.3 | 17.08 |
| *11 | −27.49537 | 4.958 | | | | | 17.18 |
| 12 | −12.82872 | 0.600 | 2.00100 | 29.13 | 0.59952 | 4.4 | 17.95 |
| 13 | −23.69276 | 4.944 | | | | | 20.20 |
| Simg | −69.97078 | | | | | | |

TABLE 2
Example 1

| | |
|---|---|
| f | 23.705 |
| Bf | 4.944 |
| FNo. | 2.08 |
| 2ω [°] | 61.2 |

TABLE 3
Example 1

| Sn | 8 | 9 | 10 | 11 |
|---|---|---|---|---|
| KA | 1.0000000E+00 | 1.0000000E+00 | 1.0000000E+00 | 1.0000000E+00 |
| A3 | 1.5517946E−04 | 4.4812897E−04 | 5.2767558E−04 | 3.1650508E−04 |
| A4 | 7.3278900E−05 | −1.5016055E−04 | −5.7609786E−06 | 1.1796350E−04 |
| A5 | −1.9782015E−04 | 3.3004345E−05 | −1.6411114E−05 | 2.5522495E−06 |
| A6 | 1.0502739E−04 | −1.4848034E−05 | 1.6243703E−05 | −1.4677075E−05 |
| A7 | −3.4609645E−05 | 5.0103187E−06 | −4.1380261E−06 | 5.3603763E−06 |
| A8 | 6.9476937E−06 | −1.2650259E−06 | 5.0852223E−07 | −6.8463927E−07 |
| A9 | −8.2686237E−07 | 1.8878264E−07 | −1.6396584E−09 | 8.0654642E−10 |
| A10 | 4.6801577E−08 | −1.5642625E−08 | −8.2060645E−09 | 1.0115438E−08 |
| A11 | −5.8285342E−10 | 2.8378939E−10 | 1.0128982E−09 | −1.2010802E−09 |
| A12 | 2.2358999E−10 | 3.3439049E−11 | −3.1633598E−11 | 6.0292810E−11 |
| A13 | −6.8067337E−11 | 4.7095645E−12 | −2.6816419E−12 | −3.8850577E−12 |
| A14 | 6.9685347E−12 | −1.1916041E−12 | 1.9418142E−13 | 6.6327376E−13 |
| A15 | −3.4946104E−13 | 9.0674027E−14 | 6.6051830E−15 | −5.2579673E−14 |
| A16 | 7.4101679E−15 | −2.4717228E−15 | −8.8054467E−16 | 1.1467770E−15 |
| A17 | −1.1248633E−16 | −3.9164904E−16 | −3.3847349E−18 | 2.3856872E−17 |
| A18 | 5.7919877E−17 | 2.4486094E−17 | −1.0320174E−18 | −6.4635901E−19 |
| A19 | 8.0567119E−18 | −3.5371248E−18 | 3.1964277E−19 | −2.7912871E−19 |
| A20 | −1.1874578E−18 | 6.7075233E−19 | −5.6599187E−21 | 2.7551750E−20 |

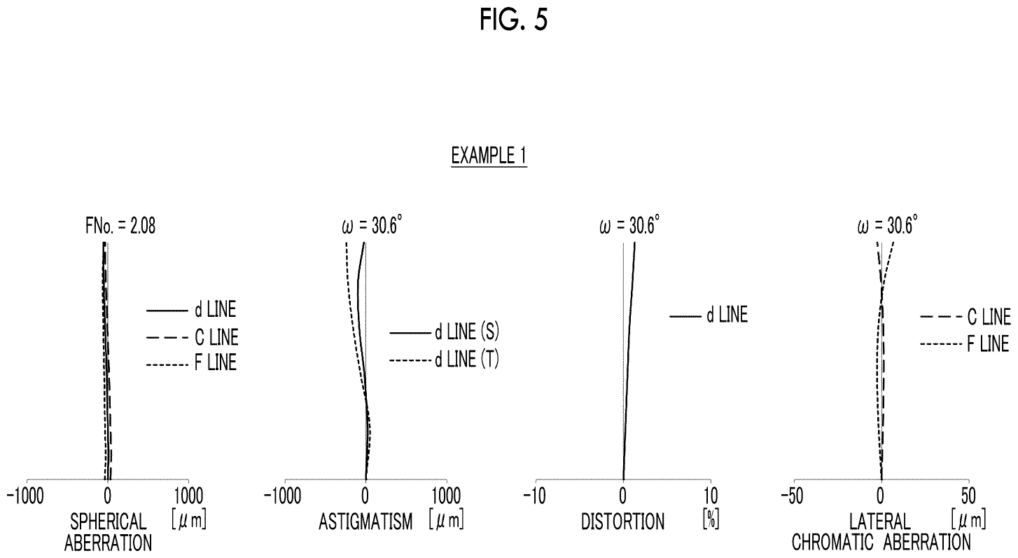

FIG. 5 illustrates each aberration diagram of Example 1 in a state where the infinite distance object is focused on. In FIG. 5, a spherical aberration, an astigmatism, a distortion, and a lateral chromatic aberration are illustrated in this order from the left. In the spherical aberration diagram, aberrations on the d line, the C line, and the F line are illustrated by a solid line, a long broken line, and a short broken line, respectively. In the astigmatism diagram, an aberration on the d line in a sagittal direction is illustrated by a solid line, and an aberration on the d line in a tangential direction is illustrated by a short broken line. In the distortion diagram, an aberration on the d line is illustrated by a solid line. In the lateral chromatic aberration diagram, aberrations on the C line and the F line are illustrated by a long broken line and a short broken line, respectively. In the spherical aberration diagram, a value of the F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise specified. Thus, duplicate descriptions will be omitted below.

### Example 2

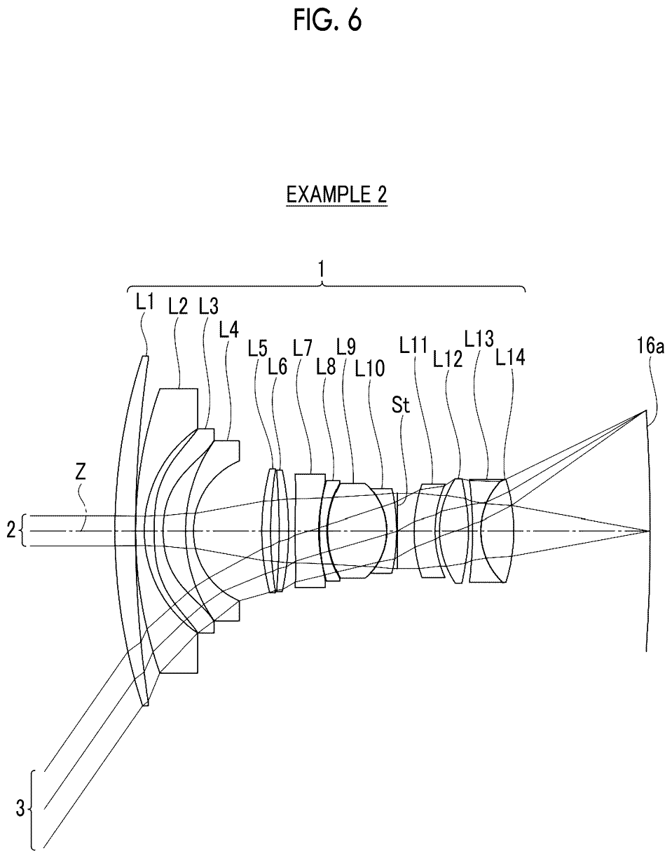

The cross-sectional view and the luminous fluxes of Example 2 are illustrated in FIG. 6. The imaging optical system 1 of Example 2 consists of lenses L1 to L10, the aperture stop St, and lenses L11 to L14 in this order from the object side to the image side. The imaging surface 16a of Example 2 has a curved shape having a concave surface toward the object side.

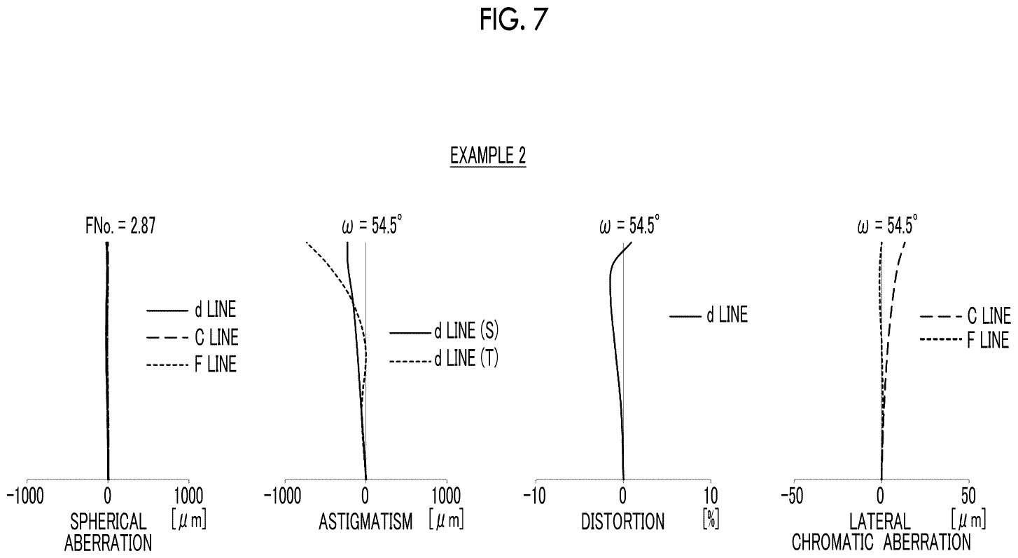

For Example 2, basic lens data is shown in Table 4, specifications are shown in Table 5, aspherical coefficients are shown in Table 6, and each aberration diagram is illustrated in FIG. 7.

TABLE 4
Example 2

| Sn | R | D | Nd | νd | θgF | dN/dT | ED |
|---|---|---|---|---|---|---|---|
| 1 | 94.96899 | 3.624 | 1.70000 | 48.10 | 0.56036 | 2.7 | 60.00 |
| 2 | 194.54746 | 0.010 | | | | | 58.45 |
| 3 | 71.48788 | 1.532 | 1.67790 | 50.67 | 0.55548 | 3.8 | 48.69 |
| 4 | 20.99381 | 1.744 | | | | | 35.00 |
| *5 | 49.84493 | 1.574 | 1.58913 | 61.13 | 0.54067 | 3.2 | 34.95 |
| *6 | 19.35509 | 3.957 | | | | | 30.85 |
| 7 | 26.00960 | 1.381 | 1.57957 | 53.74 | 0.55195 | 2.7 | 30.77 |
| 8 | 12.88219 | 12.056 | | | | | 23.90 |
| 9 | 40.69200 | 1.555 | 1.85883 | 30.00 | 0.59793 | 4.6 | 21.21 |
| 10 | 64.39567 | 1.489 | | | | | 20.81 |
| 11 | −123.55127 | 1.673 | 2.00272 | 19.32 | 0.64514 | 7.7 | 20.72 |
| 12 | −48.93626 | 1.106 | | | | | 20.57 |
| *13 | 65.60183 | 4.185 | 1.91082 | 35.25 | 0.58224 | 5.3 | 18.79 |
| *14 | 21.28747 | 0.149 | | | | | 17.15 |
| 15 | 30.53348 | 1.313 | 1.96300 | 24.11 | 0.62126 | 0.6 | 17.10 |
| 16 | 16.12028 | 0.120 | | | | | 16.16 |
| 17 | 16.06455 | 10.320 | 1.75106 | 43.08 | 0.56833 | 6.5 | 16.20 |
| 18 | −10.45480 | 1.738 | 1.83481 | 42.74 | 0.56490 | 3.8 | 14.46 |
| 19 | −31.66350 | 0.129 | | | | | 13.62 |
| 20 (St) | ∞ | 2.963 | | | | | 12.87 |
| 21 | 23.64550 | 3.700 | 1.57957 | 53.74 | 0.55195 | 2.7 | 15.39 |
| 22 | 19.11972 | 0.776 | | | | | 15.95 |
| 23 | 15.75589 | 5.104 | 1.72342 | 38.03 | 0.58294 | 4.7 | 17.84 |
| *24 | −27.02637 | 0.716 | | | | | 17.76 |
| 25 | −69.96714 | 1.453 | 2.00100 | 29.13 | 0.59952 | 4.4 | 17.22 |
| 26 | 11.98972 | 5.803 | 1.45600 | 91.37 | 0.53439 | −6 | 16.80 |
| 27 | −28.62326 | 24.046 | | | | | 17.64 |
| Simg | −299.80712 | | | | | | |

TABLE 5
Example 2

| | |
|---|---|
| f | 14.601 |
| Bf | 24.046 |
| FNo. | 2.87 |
| 2ω [°] | 109.0 |

TABLE 6
Example 2

| Sn | 5 | 6 | 13 |
|---|---|---|---|
| KA | 5.5629192E+00 | −2.8833116E−01 | −1.2273788E+02 |
| A3 | 0.0000000E+00 | 0.0000000E+00 | 0.0000000E+00 |
| A4 | 1.3980527E−04 | 1.4838259E−04 | −6.3758948E−05 |
| A5 | −3.2083552E−07 | 3.5957814E−07 | −1.9335264E−07 |
| A6 | −4.6516233E−07 | 3.6870196E−08 | −2.7419201E−08 |
| A7 | −5.4883959E−09 | 1.8751260E−10 | −1.3360005E−08 |
| A8 | 1.7051217E−09 | −3.9655331E−09 | 5.1969628E−09 |
| A9 | −2.3511779E−11 | −1.2489649E−11 | −1.2335597E−10 |
| A10 | −5.6435768E−12 | 1.0167748E−11 | −2.8192799E−11 |
| A11 | 4.8009843E−13 | 7.6239292E−13 | 2.3704239E−12 |
| A12 | −1.6702301E−14 | −8.2438540E−14 | 3.7617470E−15 |
| A13 | −3.0568374E−16 | 1.9425774E−15 | −1.7928932E−14 |
| A14 | 5.4015090E−17 | 1.8340501E−17 | 1.8032280E−15 |
| A15 | −1.8195885E−18 | −2.7684345E−18 | −4.4501858E−17 |
| A16 | 1.4000294E−20 | 9.6762336E−20 | −3.3208950E−18 |

| Sn | 14 | 24 |
|---|---|---|
| KA | 1.3846880E+00 | 2.4212001E+00 |
| A3 | 0.0000000E+00 | 0.0000000E+00 |
| A4 | −1.5640580E−04 | 7.6186745E−05 |
| A5 | −1.2582728E−06 | 7.5572132E−07 |
| A6 | 1.1912213E−06 | −1.1735904E−07 |
| A7 | −6.0474189E−08 | 3.3168767E−09 |
| A8 | 2.4066577E−09 | −3.0196902E−09 |
| A9 | −1.0141162E−09 | −3.2350999E−10 |
| A10 | 3.4706733E−11 | 1.7241717E−10 |
| A11 | 8.4094256E−12 | −2.4384896E−11 |
| A12 | 1.5965929E−12 | 2.0378147E−12 |
| A13 | −4.0607339E−13 | 1.2824445E−13 |
| A14 | 3.2825113E−14 | −4.5866504E−14 |
| A15 | −1.9237562E−15 | 2.9184124E−15 |
| A16 | 6.2296530E−17 | −3.6373488E−17 |

### Example 3

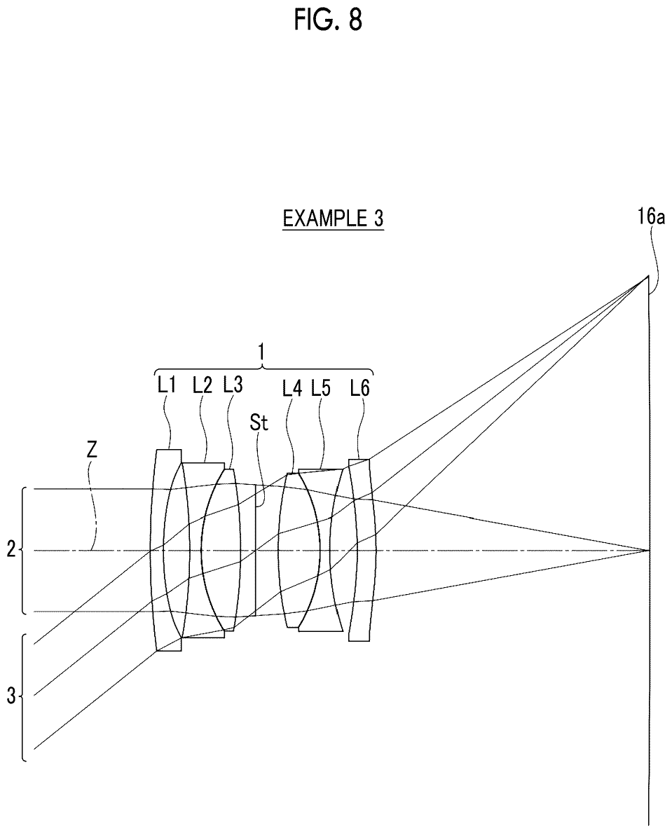

The cross-sectional view and the luminous fluxes of Example 3 are illustrated in FIG. 8. The imaging optical system 1 of Example 3 consists of the lenses L1 to L3, the aperture stop St, and the lenses L4 to L6 in this order from the object side to the image side. The imaging surface 16a of Example 3 has a curved shape having a concave surface toward the object side.

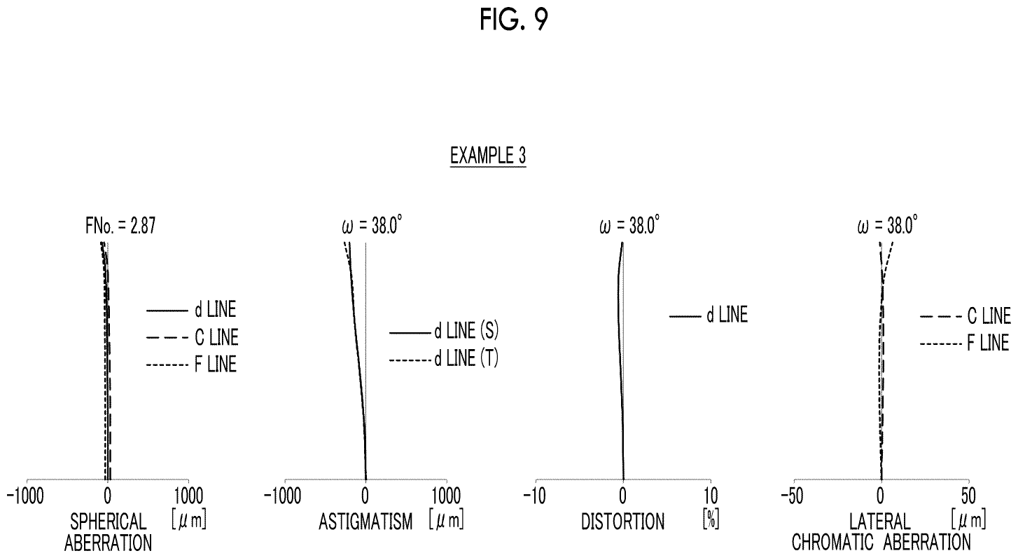

For Example 3, basic lens data is shown in Table 7, specifications are shown in Table 8, aspherical coefficients are shown in Table 9, and each aberration diagram is illustrated in FIG. 9.

TABLE 7
Example 3

| Sn | R | D | Nd | νd | θgF | dN/dT | ED |
|---|---|---|---|---|---|---|---|
| 1 | 39.45185 | 0.700 | 1.51633 | 64.14 | 0.53531 | 2.2 | 10.40 |
| *2 | 15.19690 | 1.396 | | | | | 9.06 |
| 3 | −25.50451 | 0.610 | 1.63980 | 34.47 | 0.59233 | 1.3 | 9.02 |
| 4 | 7.69273 | 2.093 | 1.87070 | 40.73 | 0.56825 | 3.9 | 8.35 |
| 5 | −23.57425 | 0.800 | | | | | 8.16 |
| 6 (St) | ∞ | 1.200 | | | | | 6.74 |
| 7 | 16.62032 | 2.229 | 1.88100 | 40.14 | 0.57010 | 4.5 | 7.80 |
| 8 | −7.48969 | 0.510 | 1.68893 | 31.07 | 0.60041 | 1.3 | 7.96 |
| 9 | 13.13673 | 1.441 | | | | | 8.39 |
| *10 | −16.38059 | 1.000 | 1.77250 | 49.62 | 0.55038 | 4.9 | 8.67 |
| *11 | −16.01134 | 14.571 | | | | | 9.40 |
| Simg | −1243.0137 | | | | | | |

TABLE 8
Example 3

| | |
|---|---|
| f | 18.229 |
| Bf | 14.571 |
| FNo. | 2.87 |
| 2ω [°] | 76.0 |

TABLE 9
Example 3

| Sn | 2 | 10 | 11 |
|---|---|---|---|
| KA | 1.0000000E+00 | 1.0000000E+00 | 8.2842200E+00 |
| A4 | 4.5121463E−04 | 5.8526208E−04 | 9.4904922E−04 |
| A6 | −5.2920222E−07 | −1.4811900E−05 | 3.8791402E−06 |
| A8 | 8.6601078E−07 | 1.0187787E−06 | 1.7525153E−07 |
| A10 | −3.7772167E−08 | −5.4029542E−08 | 4.4709974E−09 |
| A12 | 9.2855146E−10 | −5.1024017E−10 | −1.2970079E−09 |
| A14 | −2.3224329E−12 | 5.2975298E−11 | 4.2611646E−11 |

### Example 4

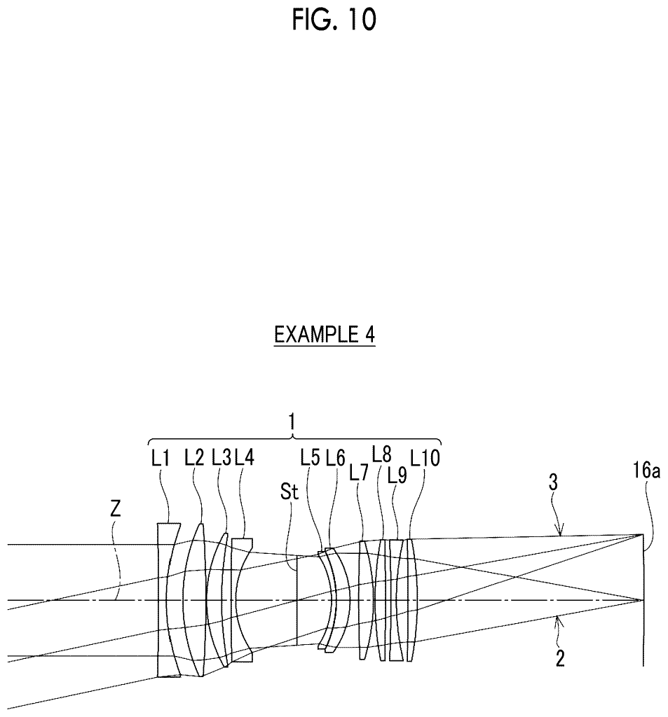

The cross-sectional view and the luminous fluxes of Example 4 are illustrated in FIG. 10. The imaging optical system 1 of Example 4 consists of the lenses L1 to L4, the aperture stop St, and the lenses L5 to L10 in this order from the object side to the image side. The imaging surface 16a of Example 4 has a curved shape having a concave surface toward the object side.

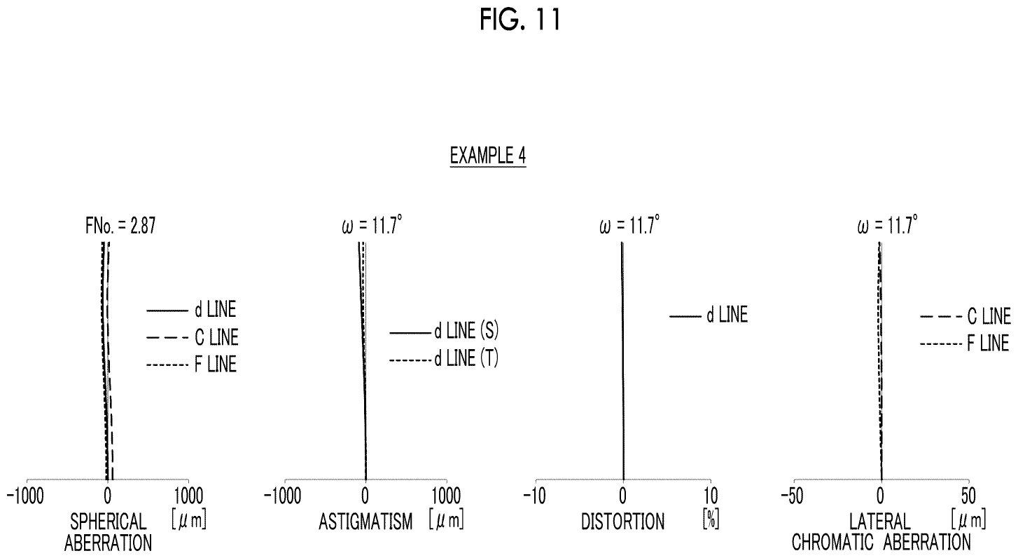

For the imaging optical system 1 of Example 4, basic lens data is shown in Table 10, specifications are shown in Table 11, and each aberration diagram is illustrated in FIG. 11.

TABLE 10
Example 4

| Sn | R | D | Nd | νd | θgF | dN/dT | ED |
|---|---|---|---|---|---|---|---|
| 1 | −540.61640 | 1.700 | 1.69895 | 30.05 | 0.60282 | 2.5 | 33.18 |
| 2 | 44.26200 | 3.546 | | | | | 32.12 |
| 3 | 38.92905 | 5.094 | 1.88100 | 40.14 | 0.57010 | 4.5 | 32.89 |
| 4 | −223.24468 | 0.150 | | | | 4.2 | 32.61 |
| 5 | 28.41905 | 3.352 | 1.81600 | 46.62 | 0.55682 | 4.2 | 28.79 |
| 6 | 73.86697 | 2.097 | | | | | 28.03 |
| 7 | 842.49194 | 1.000 | 1.54814 | 45.78 | 0.56859 | 1.1 | 26.63 |
| 8 | 19.14478 | 13.513 | | | | | 22.50 |
| 9 (St) | ∞ | 7.681 | | | | | 19.35 |
| 10 | −17.91660 | 1.064 | 1.92119 | 23.96 | 0.62025 | 2.4 | 19.80 |
| 11 | −23.82723 | 3.047 | 1.43700 | 95.10 | 0.53364 | −6.3 | 21.10 |
| 12 | −18.76043 | 1.918 | | | | | 22.44 |
| 13 | 315.16480 | 3.237 | 1.43700 | 95.10 | 0.53364 | −6.3 | 25.24 |
| 14 | −42.34441 | 0.380 | | | | | 25.54 |
| 15 | 68.47036 | 2.297 | 1.55397 | 71.76 | 0.53931 | −6.1 | 26.11 |
| 16 | −646.19995 | 1.200 | | | | | 26.08 |
| 17 | −302.42097 | 1.200 | 1.70154 | 41.15 | 0.57704 | 4.8 | 25.99 |
| 18 | 55.16417 | 2.585 | | | | | 25.95 |
| 19 | −609.18380 | 2.080 | 1.80000 | 29.84 | 0.60178 | 2.8 | 26.25 |
| 20 | −66.73013 | 50.017 | | | | | 26.43 |
| Simg | −474.02342 | | | | | | |

TABLE 11
Example 4

| | |
|---|---|
| f | 69.000 |
| Bf | 50.017 |
| FNo. | 2.87 |
| 2ω [°] | 23.4 |

### Example 5

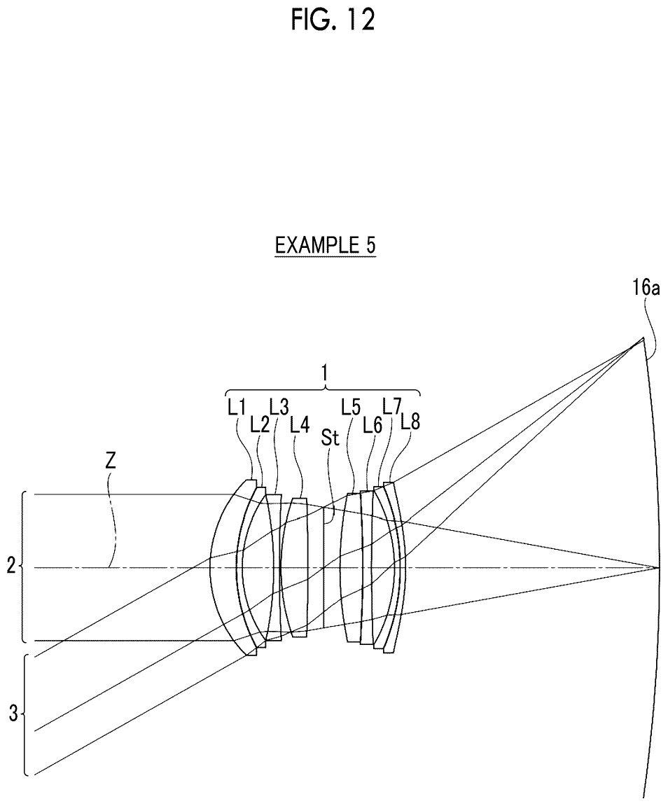

The cross-sectional view and the luminous fluxes of Example 5 are illustrated in FIG. 12. The imaging optical system 1 of Example 5 consists of the lenses L1 to L4, the aperture stop St, and the lenses L5 to L8 in this order from the object side to the image side. The imaging surface 16a of Example 5 has a curved shape having a concave surface toward the object side.

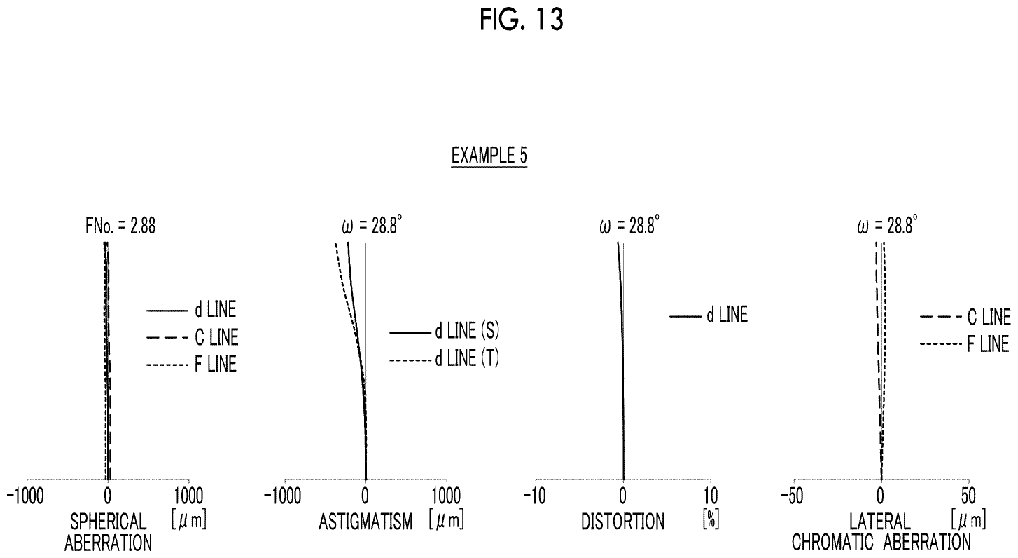

For the imaging optical system 1 of Example 5, basic lens data is shown in Table 12, specifications are shown in Table 13, aspherical coefficients are shown in Table 14, and each aberration diagram is illustrated in FIG. 13.

TABLE 12
Example 5

| Sn | R | D | Nd | νd | θgF | dN/dT | ED |
|---|---|---|---|---|---|---|---|
| *1 | 7.41616 | 1.674 | 1.81600 | 46.62 | 0.55682 | 4.2 | 10.82 |
| 2 | 10.07191 | 0.374 | 1.85896 | 22.73 | 0.62844 | 0.0 | 9.86 |
| 3 | 7.52792 | 1.994 | | | | | 9.00 |
| 4 | −20.46790 | 0.365 | 1.59551 | 39.22 | 0.58042 | 2.3 | 9.00 |
| 5 | 82.37994 | 0.100 | | | | | 8.77 |
| 6 | 12.54245 | 1.708 | 1.61800 | 63.33 | 0.54414 | −4.0 | 8.55 |
| 7 | −116.28584 | 1.000 | | | | | 8.14 |
| 8 (St) | ∞ | 1.000 | | | | | 7.43 |
| 9 | 21.91849 | 1.449 | 1.65844 | 50.88 | 0.55612 | 3.6 | 8.86 |
| 10 | −69.04094 | 0.558 | 1.50137 | 56.41 | 0.54747 | 4.2 | 9.16 |
| 11 | 112.65917 | 1.455 | | | | | 9.46 |
| 12 | −9.28981 | 0.360 | 1.50137 | 56.41 | 0.54747 | 4.2 | 9.49 |
| 13 | −12.30281 | 0.350 | 1.63930 | 44.87 | 0.56843 | 2.3 | 9.98 |
| *14 | −14.06490 | 16.121 | | | | | 10.49 |
| Simg | −99.97383 | | | | | | |

TABLE 13
Example 5

| | |
|---|---|
| f | 26.007 |
| Bf | 16.121 |
| FNo. | 2.88 |
| 2ω [°] | 57.6 |

TABLE 14
Example 5

| Sn | 1 | 14 |
|---|---|---|
| KA | 1.0000000E+00 | 1.0000000E+00 |
| A4 | −2.6823099E−05 | 2.5430180E−04 |
| A6 | 2.1666217E−07 | 1.7055861E−06 |
| A8 | −3.0543044E−08 | 6.2560935E−08 |
| A10 | 5.5864107E−10 | −1.6146231E−09 |

Table 15 shows the corresponding values of Conditional Expressions (1) to (20) in Examples 1 to 5. Preferable ranges of the conditional expressions may be set using the corresponding values of the examples shown in Table 15 as the upper limits or the lower limits of the conditional expressions.

TABLE 15

| Expression | | | | | | |
|---|---|---|---|---|---|---|
| Number | | Example 1 | Example 2 | Example 3 | Example 4 | Example 5 |
| (1) | Bf/Ri | −0.07 | −0.08 | −0.01 | −0.11 | −0.16 |
| (2) | (Rr + Ri)/(Rr − Ri) | −2.02 | −1.21 | −1.03 | −1.33 | −1.33 |
| (3) | EDf/TL | 0.43 | 0.64 | 0.39 | 0.31 | 0.38 |
| (4) | TL/f | 1.22 | 6.45 | 1.46 | 1.55 | 1.10 |
| (5) | (TL/f) × FNo | 2.52 | 18.52 | 4.18 | 4.46 | 3.15 |
| (6) | EDf/(f × tan ω) | 0.87 | 2.91 | 0.73 | 2.34 | 0.75 |
| (7) | Bf/(f × tan ω) | 0.35 | 1.16 | 1.02 | 3.52 | 1.12 |
| (8) | Bf/TL | 0.17 | 0.26 | 0.55 | 0.47 | 0.57 |
| (9) | TL/(f × tan ω) | 2.03 | 4.56 | 1.85 | 7.53 | 1.98 |
| (10) | Ndm | 2.00 | 2.00 | 1.88 | 1.92 | 1.86 |
| (11) | Ndm + 0.01 × νdm | 2.29 | 2.20 | 2.28 | 2.16 | 2.09 |
| (12) | \|(dN/dT)m\| | 4.40 | 7.70 | 4.90 | 6.30 | 4.20 |
| (13) | TL/Ri | −0.41 | −0.31 | −0.02 | −0.23 | −0.29 |
| (14) | EDf/EDr | 0.57 | 3.39 | 1.11 | 1.25 | 1.01 |
| (15) | Ltot/f | 1.01 | 4.81 | 0.66 | 0.83 | 0.48 |
| (16) | (Ltot/f) × FNo | 2.09 | 13.79 | 1.89 | 2.38 | 1.37 |
| (17) | Ltot/(f × tan ω) | 1.68 | 3.40 | 0.84 | 4.02 | 0.86 |
| (18) | f/ff | 0.73 | 0.03 | 0.44 | 0.39 | 0.77 |
| (19) | f/fr | 0.19 | 0.40 | 0.55 | 0.91 | 0.27 |
| (20) | L1ST/Ltot | 0.14 | 0.71 | 0.47 | 0.53 | 0.58 |

While the disclosed technology has been described above using the embodiment and the examples, the disclosed technology is not limited to the embodiment and the examples, and various modifications can be made. For example, the curvature radius, the surface spacing, the refractive index, the Abbe number, and the aspherical coefficient of each lens are not limited to the values shown in each example and may have other values. The imaging optical system according to the embodiment of the present disclosure may be a variable magnification optical system such as a zoom lens or a varifocal lens.

Various modifications can also be made to the imaging apparatus according to the embodiment of the present disclosure. The imaging apparatus according to the embodiment of the present disclosure may be a camera of a mirrorless type or a camera of a type other than the mirrorless type. The imaging apparatus according to the embodiment of the present disclosure is not limited to a digital camera and may be a film camera. In a case where the imaging apparatus is a film camera, a film surface is the imaging surface. In addition, the imaging apparatus according to the embodiment of the present disclosure can have various aspects of a video camera, a security camera, a video capturing camera, a broadcasting camera, and the like.

The following appendixes are further disclosed with respect to the embodiment and the examples described above.

### Appendix 1

An imaging apparatus comprising an imaging optical system including a plurality of lenses, and a curved imaging surface that is disposed at an image forming position of the imaging optical system and that has a concave surface toward an object side, in which in a case where a back focus of the imaging optical system as an air conversion distance is denoted by Bf, a curvature radius of the imaging surface is denoted by Ri, a paraxial curvature radius of a lens surface of the imaging optical system closest to an image side is denoted by Rr, an effective diameter of a lens surface of the imaging optical system closest to the object side is denoted by EDf, and a sum of Bf and a distance on an optical axis from the lens surface of the imaging optical system closest to the object side to the lens surface of the imaging optical system closest to the image side is denoted by TL, Conditional Expressions (1), (2), and (3) are satisfied, which are represented by

$$- 0.3 < Bf / Ri < - 0.005 \qquad ( 1 )$$

$$- 5 < ( Rr + Ri ) / ( Rr - Ri ) < - 0.1 \qquad ( 2 )$$

$$0.1 < EDf / TL < 0.8 . \qquad ( 3 )$$

### Appendix 2

The imaging apparatus according to Appendix 1, in which in a case where a focal length of the imaging optical system is denoted by f, Conditional Expression (4) is satisfied, which is represented by

$$0.3 < TL / f < 9. \qquad ( 4 )$$

### Appendix 3

The imaging apparatus according to Appendix 1 or 2, in which in a case where a focal length of the imaging optical system is denoted by f, and an F-number of the imaging optical system is denoted by FNo, Conditional Expression (5) is satisfied, which is represented by

$$0.5 < ( TL / f ) \times FNo < 23. \qquad ( 5 )$$

### Appendix 4

The imaging apparatus according to any one of Appendixes 1 to 3, in which in a case where a focal length of the imaging optical system is denoted by f, and a maximum half angle of view of the imaging optical system is denoted by ω, Conditional Expression (6) is satisfied, which is represented by

$$0.3 < EDf / ( f \times tan ω ) < 5. \qquad ( 6 )$$

### Appendix 5

The imaging apparatus according to any one of Appendixes 1 to 4, in which in a case where a focal length of the imaging optical system is denoted by f, and a maximum half angle of view of the imaging optical system is denoted by ω, Conditional Expression (7) is satisfied, which is represented by

$$0.1 < Bf / ( f \times tan ω ) < 5. \qquad ( 7 )$$

### Appendix 6

The imaging apparatus according to any one of Appendixes 1 to 5, in which Conditional Expression (8) is satisfied, which is represented by

$$0.1 < Bf / TL < 0.8 . \qquad ( 8 )$$

### Appendix 7

The imaging apparatus according to any one of Appendixes 1 to 6, in which in a case where a focal length of the imaging optical system is denoted by f, and a maximum half angle of view of the imaging optical system is denoted by ω, Conditional Expression (9) is satisfied, which is represented by

$$0.5 < TL / ( f \times tan ω ) < 10. \qquad ( 9 )$$

### Appendix 8

The imaging apparatus according to any one of Appendixes 1 to 7, in which in a case where a lens having a maximum refractive index with respect to a d line among lenses included in the imaging optical system is denoted by an LNdmax lens, the refractive index of the LNdmax lens with respect to the d line is denoted by Ndm, and an Abbe number of the

LNdmax lens based on the d line is denoted by vdm, Conditional Expressions (10) and (11) are satisfied, which are represented by

$$1.7 < Ndm < 2.15 \qquad ( 10 )$$

$$1.95 < Ndm + 0.01 \times vdm < 2.4 . \qquad ( 11 )$$

### Appendix 9

The imaging apparatus according to any one of Appendixes 1 to 8, in which in a case where a maximum value of absolute values of temperature coefficients of refractive indexes of all lenses included in the imaging optical system with respect to a d line within a temperature range of 20° C. to 40° C. is denoted by |(dN/dT)m|×10⁻⁶, and a unit of |(dN/dT)m|×10⁻⁶ is denoted by ° C.⁻¹, Conditional Expression (12) is satisfied, which is represented by

$$0 < \vert ( dN / dT ) m \vert < 12. \qquad ( 12 )$$

### Appendix 10

The imaging apparatus according to any one of Appendixes 1 to 9, in which Conditional Expression (13) is satisfied, which is represented by

$$- 0.8 < TL / Ri < - 0.02 . \qquad ( 13 )$$

### Appendix 11

The imaging apparatus according to any one of Appendixes 1 to 10, in which in a case where an effective diameter of the lens surface of the imaging optical system closest to the image side is denoted by EDr, Conditional Expression (14) is satisfied, which is represented by

$$0.3 < EDf / EDr < 5. \qquad ( 14 )$$

### Appendix 12

The imaging apparatus according to any one of Appendixes 1 to 11, in which in a case where a distance on the optical axis from the lens surface of the imaging optical system closest to the object side to the lens surface of the imaging optical system closest to the image side is denoted by Ltot, and a focal length of the imaging optical system is denoted by f, Conditional Expression (15) is satisfied, which is represented by

$$0.2 < Ltot / f < 6. \qquad ( 15 )$$

### Appendix 13

The imaging apparatus according to any one of Appendixes 1 to 12, in which in a case where a distance on the optical axis from the lens surface of the imaging optical system closest to the object side to the lens surface of the imaging optical system closest to the image side is denoted by Ltot, a focal length of the imaging optical system is denoted by f, and an F-number of the imaging optical system is denoted by FNo, Conditional Expression (16) is satisfied, which is represented by

$$0.6 < ( Ltot / f ) \times FNo < 15. \qquad ( 16 )$$

### Appendix 14

The imaging apparatus according to any one of Appendixes 1 to 13, in which in a case where a distance on the optical axis from the lens surface of the imaging optical system closest to the object side to the lens surface of the imaging optical system closest to the image side is denoted by Ltot, a focal length of the imaging optical system is denoted by f, and a maximum half angle of view of the imaging optical system is denoted by ω, Conditional Expression (17) is satisfied, which is represented by

$$0.45 < Ltot / ( f \times tan ω ) < 6. \qquad ( 17 )$$

### Appendix 15

The imaging apparatus according to any one of Appendixes 1 to 14, in which the lens surface of the imaging optical system closest to the image side has a convex shape.

### Appendix 16

The imaging apparatus according to any one of Appendixes 1 to 15, in which the imaging optical system includes an aperture stop, and in a case where a focal length of the imaging optical system is denoted by f, and a combined focal length of all lenses in the imaging optical system closer to the object side than the aperture stop is denoted by ff, Conditional Expression (18) is satisfied, which is represented by

$$0.01 < f / ff < 1.3 . \qquad ( 18 )$$

### Appendix 17

The imaging apparatus according to any one of Appendixes 1 to 16, in which the imaging optical system includes an aperture stop, and in a case where a focal length of the imaging optical system is denoted by f, and a combined focal length of all lenses in the imaging optical system closer to the image side than the aperture stop is denoted by fr, Conditional Expression (19) is satisfied, which is represented by

$$0.1 < f / fr < 1.5 . \qquad ( 19 )$$

### Appendix 18

The imaging apparatus according to any one of Appendixes 1 to 17, in which the imaging optical system includes an aperture stop, and in a case where a distance on the optical axis from the lens surface of the imaging optical system closest to the object side to the aperture stop is denoted by L1ST, and a distance on the optical axis from the lens surface of the imaging optical system closest to the object side to the lens surface of the imaging optical system closest to the image side is denoted by Ltot, Conditional Expression (20) is satisfied, which is represented by

$$0.1 < L 1 ST / Ltot < 0.9 . \qquad ( 20 )$$

What is claimed is:

1. An imaging apparatus comprising:
an imaging optical system including a plurality of lenses; and
a curved imaging surface that is disposed at an image forming position of the imaging optical system and that has a concave surface toward an object side,
wherein in a case where a back focus of the imaging optical system as an air conversion distance is denoted by Bf, a curvature radius of the imaging surface is denoted by Ri, a paraxial curvature radius of a lens surface of the imaging optical system closest to an image side is denoted by Rr, an effective diameter of a lens surface of the imaging optical system closest to the object side is denoted by EDf, and a sum of Bf and a distance on an optical axis from the lens surface of the imaging optical system closest to the object side to the lens surface of the imaging optical system closest to the image side is denoted by TL, Conditional Expressions (1), (2), and (3) are satisfied, which are represented by
$$- 0.3 < Bf / Ri < - 0.005 \qquad ( 1 )$$
$$- 5 < ( Rr + Ri ) / ( Rr - Ri ) < - 0.1 \qquad ( 2 )$$
$$0.1 < EDf / TL < 0.8 . \qquad ( 3 )$$

2. The imaging apparatus according to claim 1,
wherein in a case where a focal length of the imaging optical system is denoted by f, Conditional Expression (4) is satisfied, which is represented by
$$0.3 < TL / f < 9. \qquad ( 4 )$$

3. The imaging apparatus according to claim 1,
wherein in a case where a focal length of the imaging optical system is denoted by f, and an F-number of the imaging optical system is denoted by FNo, Conditional Expression (5) is satisfied, which is represented by
$$0.5 < ( TL / f ) \times FNo < 23. \qquad ( 5 )$$

4. The imaging apparatus according to claim 1,
wherein in a case where a focal length of the imaging optical system is denoted by f, and a maximum half angle of view of the imaging optical system is denoted by ω, Conditional Expression (6) is satisfied, which is represented by
$$0.3 < EDf / ( f \times tan ω ) < 5. \qquad ( 6 )$$

5. The imaging apparatus according to claim 1,
wherein in a case where a focal length of the imaging optical system is denoted by f, and a maximum half angle of view of the imaging optical system is denoted by ω, Conditional Expression (7) is satisfied, which is represented by
$$0.1 < Bf / ( f \times tan ω ) < 5. \qquad ( 7 )$$

6. The imaging apparatus according to claim 1,
wherein Conditional Expression (8) is satisfied, which is represented by
$$0.1 < Bf / TL < 0.8 . \qquad ( 8 )$$

7. The imaging apparatus according to claim 1,
wherein in a case where a focal length of the imaging optical system is denoted by f, and a maximum half angle of view of the imaging optical system is denoted by ω, Conditional Expression (9) is satisfied, which is represented by
$$0.5 < TL / ( f \times tan ω ) < 10. \qquad ( 9 )$$

8. The imaging apparatus according to claim 1,
wherein in a case where a lens having a maximum refractive index with respect to a d line among lenses included in the imaging optical system is denoted by an LNdmax lens, the refractive index of the LNdmax lens with respect to the d line is denoted by Ndm, and an Abbe number of the LNdmax lens based on the d line is denoted by vdm, Conditional Expressions (10) and (11) are satisfied, which are represented by
$$1 \text{.7} < Ndm < 2.15 \qquad ( 10 )$$
$$1.95 < N d m + 0.01 \times v d m < 2.4 .$$

9. The imaging apparatus according to claim 1,
wherein in a case where a maximum value of absolute values of temperature coefficients of refractive indexes of all lenses included in the imaging optical system with respect to a d line within a temperature range of 20° C. to 40° C. is denoted by |(dN/dT)m|×10⁻⁶, and a unit of |(dN/dT)m|×10⁶ is denoted by ° C.⁻¹, Conditional Expression (12) is satisfied, which is represented by
$$0 < \vert ( dN / dT ) m \vert < 12. \qquad ( 12 )$$

10. The imaging apparatus according to claim 1,
wherein Conditional Expression (13) is satisfied, which is represented by
$$- 0.8 < TL / Ri < - 0.02 . \qquad ( 13 )$$

11. The imaging apparatus according to claim 1,
wherein in a case where an effective diameter of the lens surface of the imaging optical system closest to the image side is denoted by EDr, Conditional Expression (14) is satisfied, which is represented by
$$0.3 < EDf / EDr < 5. \qquad ( 14 )$$

12. The imaging apparatus according to claim 1,
wherein in a case where a distance on the optical axis from the lens surface of the imaging optical system closest to the object side to the lens surface of the imaging optical system closest to the image side is denoted by Ltot, and a focal length of the imaging optical system is denoted by f, Conditional Expression (15) is satisfied, which is represented by
$$0.2 < L tot / f < 6. \qquad ( 15 )$$

13. The imaging apparatus according to claim 1,
wherein in a case where a distance on the optical axis from the lens surface of the imaging optical system closest to the object side to the lens surface of the imaging optical system closest to the image side is denoted by Ltot, a focal length of the imaging optical system is denoted by f, and an F-number of the imaging optical system is denoted by FNo, Conditional Expression (16) is satisfied, which is represented by
$$0.6 < ( L tot / f ) \times FNo < 15. \qquad ( 16 )$$

14. The imaging apparatus according to claim 1,
wherein in a case where a distance on the optical axis from the lens surface of the imaging optical system closest to the object side to the lens surface of the imaging optical system closest to the image side is denoted by Ltot, a focal length of the imaging optical system is denoted by f, and a maximum half angle of view of the imaging optical system is denoted by ω, Conditional Expression (17) is satisfied, which is represented by
$$0.45 < L tot / ( f \times tan ω ) < 6. \qquad ( 17 )$$

15. The imaging apparatus according to claim 1,
wherein the lens surface of the imaging optical system closest to the image side has a convex shape.

16. The imaging apparatus according to claim 1,
wherein the imaging optical system includes an aperture stop, and
in a case where a focal length of the imaging optical system is denoted by f, and a combined focal length of all lenses in the imaging optical system closer to the object side than the aperture stop is denoted by ff, Conditional Expression (18) is satisfied, which is represented by
$$0.01 < f / ff < 1.3 . \qquad ( 18 )$$

17. The imaging apparatus according to claim 1,
wherein the imaging optical system includes an aperture stop, and
in a case where a focal length of the imaging optical system is denoted by f, and a combined focal length of all lenses in the imaging optical system closer to the image side than the aperture stop is denoted by fr, Conditional Expression (19) is satisfied, which is represented by
$$0.1 < f / fr < 1.5 . \qquad ( 19 )$$

18. The imaging apparatus according to claim 1,
wherein the imaging optical system includes an aperture stop, and
in a case where a distance on the optical axis from the lens surface of the imaging optical system closest to the object side to the aperture stop is denoted by L1ST, and a distance on the optical axis from the lens surface of the imaging optical system closest to the object side to the lens surface of the imaging optical system closest to the image side is denoted by Ltot, Conditional Expression (20) is satisfied, which is represented by
$$0.1 < L 1 ST / < 0.9 . \qquad ( 20 )$$
